(19) United States
(12) Patent Application Publication
(10) Pub. No.: US 2017/0127345 A1
(43) Pub. Date: May 4, 2017

(54) Method and Device for Implementing Network Coexistence and Mobile Terminal

(71) Applicant: Leauto Intelligent Technology (BEIJING) Co. Ltd, Beijing (CN)

(72) Inventor: Liting Ge, Beijing (CN)

(73) Assignee: Leauto Intelligent Technology (BEIJING) Co. Ltd, Beijing (CN)

(21) Appl. No.: 14/966,612

(22) Filed: Dec. 11, 2015

(30) Foreign Application Priority Data
Oct. 29, 2015 (CN) 201510719678.X

(51) Int. Cl. H04W 48/18; H04W 48/16; H04W 76/02; H04L 29/12

(52) U.S. Cl. CPC H04W 48/18; H04L 61/1511; H04W 48/16; H04W 76/025; H04W 88/06

(57) ABSTRACT

The disclosure provides a method and a device for implementing network coexistence and a mobile terminal. The method comprises: detecting whether a mobile terminal is in a wireless fidelity (Wifi) network connection state; and if so, switching the network connection mode of a data link according to whether the Wifi network is a valid network. According to the method and the device for implementing network coexistence and the mobile terminal provided by the disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### FIELD OF TECHNOLOGY

The present disclosure relates to the technical field of mobile terminals, and particularly relates to a method and a device for implementing network coexistence and a mobile terminal.

### BACKGROUND

At present, many intelligent devices (e.g. automobile data recorders and the like) are connected with users' mobile terminals (e.g. mobile phones, tablet personal computers and the like) through wireless fidelity (Wifi) networks to achieve communication function.

When a user's mobile terminal and an intelligent device (e.g. an Android mobile phone and an automobile data recorder) are in a Wifi connection state, because the network connection mechanism of the mobile terminal itself is to preferentially use the Wifi network, the mobile terminal cannot access the Internet through a mobile communication network (e.g. 2nd Generation (2G) network, 3rd Generation (3G) network or 4th Generation (4G) network), namely the Wifi network cannot coexist with the mobile communication network, and the user experience is relatively poor.

### SUMMARY

The present disclosure provides a method and a device for implementing network coexistence and a mobile terminal, to implement the coexistence of a Wifi network and a mobile communication network when the mobile terminal is in a Wifi network connection state, and thus improving the user experience.

In order to achieve the above object, the present disclosure adopts the following technical solutions:

In one aspect, the embodiments of the present disclosure provide a method for implementing network coexistence, including: detecting whether a mobile terminal is in a Wifi network connection state; and if so, switching the network connection mode of a data link according to whether the Wifi network is a valid network.

In another aspect, the present disclosure provides a device for implementing network coexistence, including: a detection module for detecting whether a mobile terminal is in a Wifi network connection state; and a switching module for switching the network connection mode of a data link according to whether the Wifi network is a valid network if the mobile terminal being in the Wifi network connection state is detected.

In a further aspect, the present disclosure provides a mobile terminal, including the above device for implementing network coexistence.

According to the method and the device for implementing network coexistence and the mobile terminal provided by the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### BRIEF DESCRIPTION OF THE DRAWINGS

FIG. 1 is a schematic flow diagram of an embodiment of a method for implementing network coexistence provided by the present disclosure;

FIG. 2 is a schematic flow diagram of another embodiment of the method for implementing network coexistence provided by the present disclosure;

FIG. 3 is a structural schematic diagram of an embodiment of a device for implementing network coexistence provided by the present disclosure;

FIG. 4 is a structural schematic diagram of another embodiment of the device for implementing network coexistence provided by the present disclosure;

FIG. 5 is a structural schematic diagram of an embodiment of a mobile terminal provided by the present disclosure.

### DESCRIPTION OF THE EMBODIMENTS

A method and a device for implementing network coexistence and a mobile terminal of the embodiments of the present disclosure will be described in detail below in combination with the accompanying drawings.

### Embodiment 1

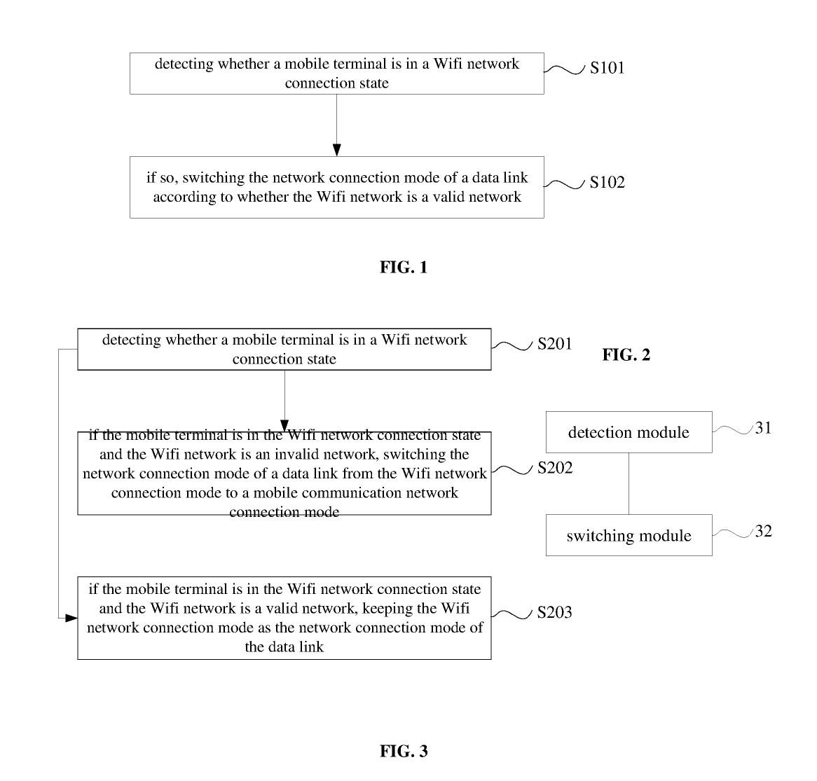

FIG. 1 is a schematic flow diagram of an embodiment of a method for implementing network coexistence provided by the present disclosure. The method for implementing network coexistence in the embodiment of the present disclosure can be applied to various mobile terminals (e.g. mobile phones, tablet personal computers and the like) with Wifi network connection and mobile communication network functions. As shown in FIG. 1, the method for implementing network coexistence in the embodiment of the present disclosure specifically may include the following steps:

S101, whether a mobile terminal is in a Wifi network connection state is detected.

Specifically, for example, when the mobile terminal is connected with an intelligent device (such as automobile data recorder and the like) through a Wifi network, or when the mobile terminal is connected with a server of a broadband network provider through a Wifi network, the mobile terminal being in the Wifi network connection state can be detected.

S102, if so, the network connection mode of a data link is switched according to whether the Wifi network is a valid network.

Specifically, if the network connection mechanism of the mobile terminal itself is to preferentially use Wifi network connection when a Wifi network and a mobile communication network coexist, when the mobile terminal is in the Wifi network connection state, the network connection mode of the data link is defaulted as the Wifi network connection mode. When the mobile terminal being in the Wifi network connection state is detected, whether the Wifi network is a valid network capable of communicating with the Internet is judged first, e.g. the Wifi network between the mobile terminal and the intelligent device (such as automobile data recorder and the like) is an invalid network, and the Wifi network between the mobile terminal and the server of the broadband network provider is a valid network. Whether the network connection mode of the data link is switched is determined according to whether the Wifi network is a valid network, i.e. the network connection mode of the data link being a Wifi network connection mode or a mobile communication network connection mode is determined.

In the method for implementing network coexistence in the embodiment of the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### Embodiment 2

FIG. 2 is a schematic flow diagram of another embodiment of the method for implementing network coexistence in the present disclosure. The method for implementing network coexistence in the embodiment of the present disclosure can be applied to various mobile terminals (e.g. mobile phones, tablet personal computers and the like) with Wifi network connection and mobile communication network functions. As shown in FIG. 2, the method for implementing network coexistence in the embodiment of the present disclosure is a feasible implementation of the method for implementing network coexistence in the embodiment shown in FIG. 1, and specifically may include the following steps:

S201, whether a mobile terminal is in a Wifi network connection state is detected.

Specifically, for the specific process of step S201, reference may be made to the relevant description of step S101 in the embodiment shown in FIG. 1, which is not described redundantly herein.

Step S102 in the embodiment shown by FIG. 1 specifically may include the following steps S202 and S203.

S202, if the mobile terminal is in the Wifi network connection state and the Wifi network is an invalid network, the network connection mode of a data link is switched from the Wifi network connection mode to a mobile communication network connection mode.

In this case, the mobile communication network connection mode is a 2G network connection mode, a 3G network connection mode or a 4G network connection mode.

S203, if the mobile terminal is in the Wifi network connection state and the Wifi network is a valid network, the Wifi network connection mode is kept as the network connection mode of the data link.

Alternatively, in steps S202 and S203, when the mobile terminal is in the Wifi network connection state, whether the Wifi network is a valid network can be determined according to whether an allocated domain name system (DNS) address is acquired.

Specifically, if the allocated DNS address is acquired, the Wifi network is determined to be a valid network; and if the allocated DNS address is not acquired, the Wifi network is determined to an invalid network.

It should be noted herein that the method for implementing network coexistence in the embodiment of the present disclosure can be implemented on the basis of a framework layer of a mobile terminal network management system.

In the method for implementing network coexistence in the embodiment of the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### Embodiment 3

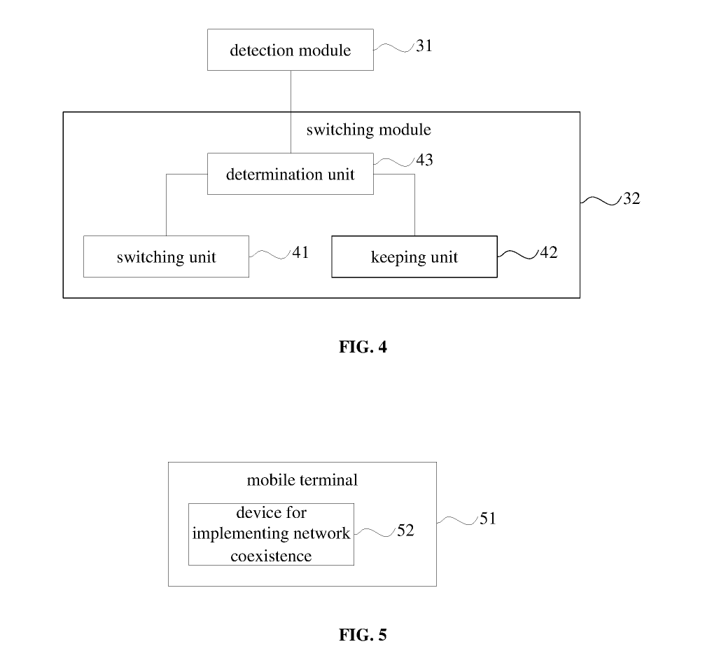

FIG. 3 is a structural schematic diagram of an embodiment of a device for implementing network coexistence provided by the present disclosure. The device for implementing network coexistence in the embodiment of the present disclosure can be arranged in various mobile terminals (e.g. mobile phones, tablet personal computers and the like) with Wifi network connection and mobile communication network functions, to execute the method for implementing network coexistence in the embodiment shown in FIG. 1. As shown in FIG. 3, the device for implementing network coexistence in the embodiment of the present disclosure specifically may include a detection module 31 and a switching module 32.

The detection module 31 is used for detecting whether a mobile terminal is in a Wifi network connection state.

The switching module 32 is used for switching the network connection mode of a data link according to whether the Wifi network is a valid network if the mobile terminal being in the Wifi network connection state is detected.

Specifically, for the specific process of achieving the function of each module in the device for implementing network coexistence in the embodiment of the present disclosure, reference may be made to the relevant description in the embodiment of the method shown in FIG. 1, which is not described redundantly herein.

According to the device for implementing network coexistence in the embodiment of the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### Embodiment 4

FIG. 4 is a structural schematic diagram of another embodiment of the device for implementing network coexistence provided by the present disclosure. The device for implementing network coexistence in the embodiment of the present disclosure can be arranged in various mobile terminals (e.g. mobile phones, tablet personal computers and the like) with Wifi network connection and mobile communication network functions, to execute the method for implementing network coexistence in the embodiment shown in FIG. 2. As shown in FIG. 4, on the basis the embodiment shown in FIG. 3, the switching module 32 of the device for implementing network coexistence in the embodiment of the present disclosure specifically may include:

a switching unit 41 for switching the network connection mode of a data link from the Wifi network connection mode to a mobile communication network connection mode if the Wifi network is an invalid network.

In this case, the mobile communication network connection mode may be a 2G network connection mode, a 3G network connection mode or a 4G network connection mode.

Further, the switching module 32 may include:

a keeping unit 42 for keeping the Wifi network connection mode as the network connection mode of the data link if the Wifi network is a valid network.

Further, the switching module 32 may include:

a determination unit 43 for determining whether the Wifi network is a valid network according to whether a DNS address is acquired.

Specifically, for the specific process of achieving the function of each module or unit in the device for implementing network coexistence in the embodiment of the present disclosure, reference may be made to the relevant description in the embodiment of the method shown in FIG. 2, which is not described redundantly herein.

According to the device for implementing network coexistence in the embodiment of the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### Embodiment 5

FIG. 5 is a structural schematic diagram of an embodiment of a mobile terminal provided by the present disclosure. The mobile terminal in the embodiment of the present disclosure specifically may be various mobile terminals (e.g. mobile phones, tablet personal computers and the like) with Wifi network connection and mobile communication network functions, and can execute the method for implementing network coexistence in the embodiment shown in FIG. 1 or FIG. 2. As shown in FIG. 5, the mobile terminal 51 in the embodiment of the present disclosure includes the device 52 for implementing network coexistence in the embodiment shown in FIG. 3 or FIG. 4.

Specifically, for the specific processes of achieving the functions of the device for implementing network coexistence in the mobile terminal 51 of the embodiment of the present disclosure, reference may be made to the relevant description in the embodiment shown in FIG. 1 or FIG. 2, which is not described redundantly herein.

According to the mobile terminal in the embodiment of the present disclosure, when the mobile terminal being in the Wifi network connection state is detected, the network connection mode of the data link is switched according to whether the Wifi network is a valid network, so that the coexistence of the Wifi network and the mobile communication network can be implemented and the user experience is improved.

### Embodiment 6

A device for implementing network coexistence, comprising: a processor; and a memory for storing instructions executable by the processor; wherein the processor is configured to: detect whether a mobile terminal is in a Wifi network connection state; and switch the network connection mode of a data link according to whether the Wifi network is a valid network if the mobile terminal being in the Wifi network connection state is detected.

Wherein the processor is further configured to: switch the network connection mode of the data link from the Wifi network connection mode to a mobile communication network connection mode if the Wifi network is an invalid network.

Wherein the processor is further configured to: keep the Wifi network connection mode as the network connection mode of the data link if the Wifi network is a valid network.

Wherein the processor is further configured to: determine whether the Wifi network is a valid network according to whether a DNS address is acquired.

Those of ordinary skill in the art could understand that implementing all of or part of the steps of the above method embodiments can be accomplished by hardware related with program instructions. The aforementioned program can be stored in a computer readable storage medium. The program when being executed, executes the steps of the above method embodiments; and the aforementioned storage medium includes various media capable of storing program codes, such as an ROM (Read-Only Memory), an RAM (Random Access Memory), a disk or an optical disk and the like.

Finally, it should be noted that the above embodiments are merely used for illustrating rather than limiting the technical solutions of the present disclosure; although the present disclosure is described in detail with reference to the aforementioned embodiments, those of ordinary skill in the art should understand that modifications may still be made on the technical solutions described in the aforementioned embodiments, or equivalent substitutions may be made to part of or all of the technical features thereof, without making, by these modifications or substitutions, the nature of the corresponding technical solutions depart from the scope of the technical solutions of the embodiments of the present disclosure.

1. A method for implementing network coexistence, comprising:
detecting whether a mobile terminal is in a Wifi network connection state; and
if so, switching the network connection mode of a data link according to whether the Wifi network is a valid network.

2. The method of claim 1, wherein switching the network connection mode of the data link according to whether the Wifi network is a valid network comprises:
if the Wifi network is an invalid network, switching the network connection mode of the data link from the Wifi network connection mode to a mobile communication network connection mode.

3. The method of claim 2, wherein the mobile communication network connection mode is a 2G network connection mode, a 3G network connection mode or a 4G network connection mode.

4. The method of claim 1, wherein switching the network connection mode of the data link according to whether the Wifi network is a valid network comprises:
if the Wifi network is a valid network, keeping the Wifi network connection mode as the network connection mode of the data link.

5. The method of claim 1, further comprising:
determining whether the Wifi network is a valid network according to whether a domain name system (DNS) address is acquired.

6. A device for implementing network coexistence, comprising:
a processor; and
a memory for storing instructions executable by the processor;
wherein the processor is configured to:
detect whether a mobile terminal is in a Wifi network connection state; and
switch the network connection mode of a data link according to whether the Wifi network is a valid network if the mobile terminal being in the Wifi network connection state is detected.

7. The device of claim 6, wherein the processor is further configured to:
switch the network connection mode of the data link from the Wifi network connection mode to a mobile communication network connection mode if the Wifi network is an invalid network.

8. The device of claim 6, wherein the processor is further configured to:
keep the Wifi network connection mode as the network connection mode of the data link if the Wifi network is a valid network.

9. The device of claim 6, wherein the processor is further configured to:
determine whether the Wifi network is a valid network according to whether a DNS address is acquired.

10. A mobile terminal, comprising the device for implementing network coexistence of claim 6.

11. The method of claim 2, further comprising:
determining whether the Wifi network is a valid network according to whether a domain name system (DNS) address is acquired.

12. The method of claim 3, further comprising:
determining whether the Wifi network is a valid network according to whether a domain name system (DNS) address is acquired.

13. The method of claim 4, further comprising:
determining whether the Wifi network is a valid network according to whether a domain name system (DNS) address is acquired.

14. The device of claim 7, wherein the processor is further configured to:
determine whether the Wifi network is a valid network according to whether a DNS address is acquired.

15. The device of claim 8, wherein the processor is further configured to:
determine whether the Wifi network is a valid network according to whether a DNS address is acquired.

16. A mobile terminal, comprising the device for implementing network coexistence of claim 7.

17. A mobile terminal, comprising the device for implementing network coexistence of claim 8.
